(19) United States
(12) Patent Application Publication
(10) Pub. No.: US 2012/0084173 A1
(43) Pub. Date: Apr. 5, 2012

(54) METHOD, COMPUTER PROGRAM PRODUCT AND SYSTEM FOR DYNAMICALLY PRICING PEERISHABLE GOODS

(76) Inventor: Anders Goran Ekholm, Helsinki (FI)

(21) Appl. No.: 13/246,062

(22) Filed: Sep. 27, 2011

Related U.S. Application Data
(60) Provisional application No. 61/386,589, filed on Sep. 27, 2010.

(51) Int. Cl. G06Q 30/00

(52) U.S. Cl. 705/26.4; 705/26.1

(57) ABSTRACT

Method for dynamically pricing perishable goods with objective of selling all items before point in time any remaining items become worthless, the method comprising:
a) controlling time-to-live parameter (TTL) corresponding to maximum time period (t=tₙ) an item is good for sale, and if time-to-live parameter (TTL)≦tₙ, then;
b) counting down update frequency time period until price is updated;
c) if interest to buy the goods is received, offering temporarily fixed price P_{freeze} equal to current price for a limited period;
d) automatically updating current price according to expressed interest;
e) accepting order at temporarily fixed price if order is received within limited time period;
f) rejecting the order if order is received after limited time period;
g) automatically updating current price in accordance with time of receiving accepted order or elapsing of update frequency time period, and
automatically repeating the steps b)-g) until time period equals time-to-live parameter.

### RELATED APPLICATIONS

This application claims the benefit of U.S. Provisional Application No. 61/386,589 filed on Sep. 27, 2010, which is hereby incorporated by reference in its entirety.

### TECHNICAL FIELD

The present invention relates to a method, computer program product and system for dynamically pricing goods, such as items of perishable goods.

### BACKGROUND

Methods and systems of different complexity for pricing products exist which have in common that they seek to predetermine a price on a product which reflects the price sensitivity of customers in order to establish optimal sales strategies, often with the object of maximizing the revenue.

Since the price sensitivity of customers depends of many factors of which some are difficult to predict or unknown, such as the customers' economic strength, their need and motive regarding buying the products, a product is often priced incorrectly, with the result that the price on the products is either set too low or too high.

If the price of the products is set too low, this normally has the effect that the products are sold out to quickly. For the vendor this means that he or she will lose revenue since a higher price would most likely have been possible.

If the price of the product is set too high, some of the products will remain unsold, which also means loss of revenues, or even devastating losses for the vendor. This risk is especially high for products like perishable goods, since all value is lost after the expired date.

The problem of incorrect pricing is ultimately due to the fact of having predetermined and fixed prices, since a predetermined price in many regards fails to encompass the actual demand in question and typically does not reflect the customers' practically infinitely complex price sensitivity.

The effects of incorrect pricing have been experienced by almost every one of us in our daily lives, where sold-out or half full airplanes, nearly empty movie theatres or music concerts and overfull shelves with expired provisions in grocery stores, all are examples of that the prices are regularly either set too low or too high, and even if some steps towards more demand-driven pricing have been taken by for instance granting last-minute discounts on tickets and the like, the underlying cause governing such methods is normally based on historical sales data or the practical experience of the seller.

Consequently, there is a need to develop better techniques for pricing products, in particular perishable items of goods, which are better suited to the actual demand.

### SUMMARY

Towards satisfaction of this need, the present invention provides a method, a computer program product and system for dynamically pricing perishable goods.

According to an aspect, this is provided by a method for dynamically pricing perishable items of goods in a goods order system according to an embodiment of the present invention.

The method comprises the steps of:

a) controlling a time-to-live parameter, TTL, corresponding to a maximum time period an item of goods is good for sale, and if time-to-live parameter TTL≦tₙ, then

b) counting down an update frequency time period until the price is updated;

c) offering the current price as a fixed price for a limited time period, also referred to as “quote”, when a buyer indicates an interest to buy a certain amount of goods;

d) updating current price of the goods offered to other potential buyers to reflect the buying interest expressed;

e) accepting order at fixed price if order to buy the goods is received before end of the limited time period;

f) automatically updating the current price of the goods in accordance with time of receiving order, and

automatically repeating the steps b)-f) until the time period equals the time-to-live parameter.

The so-called “limited time period” is typically a strictly limited time period.

According to another aspect of the present invention, there is provided a computer program product comprising computer-readable medium comprising code for causing a computer to:

a) control a time-to-live parameter TTL corresponding to a maximum time period (t=tₙ) an item of goods is good for sale, and if time-to-live parameter TTL≦tₙ, then;

b) count down an update frequency time period until the price is updated;

c) offer a fixed price equal to current price for a limited time period whenever a buyer indicates an interest to buy;

d) update current price to reflect the interest expressed by buyer;

e) accept order if it is received within the limited time period;

f) reject the order if it is received after the limited time period has elapsed;

g) automatically update the current price of the item of goods in accordance with time of receiving order to buy the goods, and

automatically repeat the steps b)-g) until the time period (t=tn) equals the time-to-live TTL parameter.

According to another aspect of the present invention, there is provided a system for dynamically pricing perishable goods in a goods order system comprising a network of interconnected nodes operatively linked, wherein the governing node comprises at least one database, a computing device and data storage, wherein the database comprises a readable and writeable register, or data memory, wherein information related to registered items of goods, in particular perishable items of goods of goods, are stored, wherein the database is arranged to store the registered items of goods for sale offered on the virtual market place and updated information relative to the contents, wherein the governing node is arranged to cause a computer to:

control a time-to-live parameter TTL corresponding to a maximum time period t=tₙ an item of goods is good for sale, and if time-to-live parameter TTL≦tₙ, then;

count down an update frequency time period until the price is updated;

offer a fixed price to a buyer for a limited time;

if order to buy the goods is received before end of the limited time period,

update the current price offered to other buyers in order to reflect the offered fixed price;

accept order if order is received within the limited time period,

reject the order if it is received after the limited time period,

automatically update the current price of the item of goods in accordance with time of receiving order or update frequency time period (ΔT_{update}), and

automatically repeat the steps above until the time period t=tₙ equals the time-to-live TTL parameter.

The invention offers significant advantages in the field of pricing items of goods, especially perishable items of goods, such as perishable goods or products, since the price of the items of goods is dynamically updated in accordance to the real demand with the objective of selling all of the items of goods for sale before the point in time any remaining items of goods become worthless. A more efficient pricing will result in benefits for all parties yielding the vendor greater revenues and the customers a product supply better suited for the demand. This means better allocation of resources in the economy; i.e. more use, less waste.

Perishable items of goods, or in other words “perishable goods”, by their nature become worthless at a certain point in time regardless whether they are used or not. Therefore it is important to rapidly pricing the items correctly as the time available for finding out the true demand function is sharply limited; this is especially true for the case of perishable goods. A dynamical price allocates the purchases over time more even and therefore make better use of the economical resources. Examples of perishable goods include but are not limited to: transportation (e.g. airline tickets), events (e.g. movie tickets), accommodation (e.g. hotel rooms), rentals (e.g. car hire), and provisions (food, beverage, etc).

Instead of taking into account the underlying factors which influences the price sensitivity of the customers, by means of the method, computer program product and system according to the present invention, the customers' behaviours are registered, measured and analyzed by the information extractable from the interaction between price and demand. The customer's price sensitivity is then used by the invention without knowing the underlying factors that influence and drive the customers' price sensitivity. The method and system according to the present invention discovers the real need from the extracted information and dynamically updates the price thereafter.

Moreover, a minimum of presumptions has to be made since the information regarding the demand is derived from both when there is no sale and when there is sale. The price is updated every time there is a sale, and at the end of each time interval.

It is also a preferred aspect of the invention that it emphasizes that this price is in fact a dynamic price in a clear way; so that customers are aware of that the price could change and also what sort of rules are valid for this sort of commerce, for example how long the current price is valid, so the customers feel safe with this. It is preferred that this communication, or dialog, with the customers is plain and straight-forward in order to achieve full acceptance for the concept of dynamic pricing of perishable goods in the public on a large scale.

### BRIEF DESCRIPTION OF THE DRAWINGS

To further explain the invention some embodiments of the invention will now be described in greater details with reference to the drawings of which:

FIG. 1 illustrates a system for communication and processing information comprising a network of interconnected nodes according to an embedment of the present invention,

FIG. 2 illustrates a governing node of the dynamic pricing system shown in FIG. 1,

FIG. 3 illustrates a flow-chart of a method according to an embodiment of the present invention,

FIG. 4 is a graph illustrating how a dynamic price is set, and

FIG. 5 is a graph illustrating how a dynamic price is set.

### DETAILED DESCRIPTION OF THE INVENTION

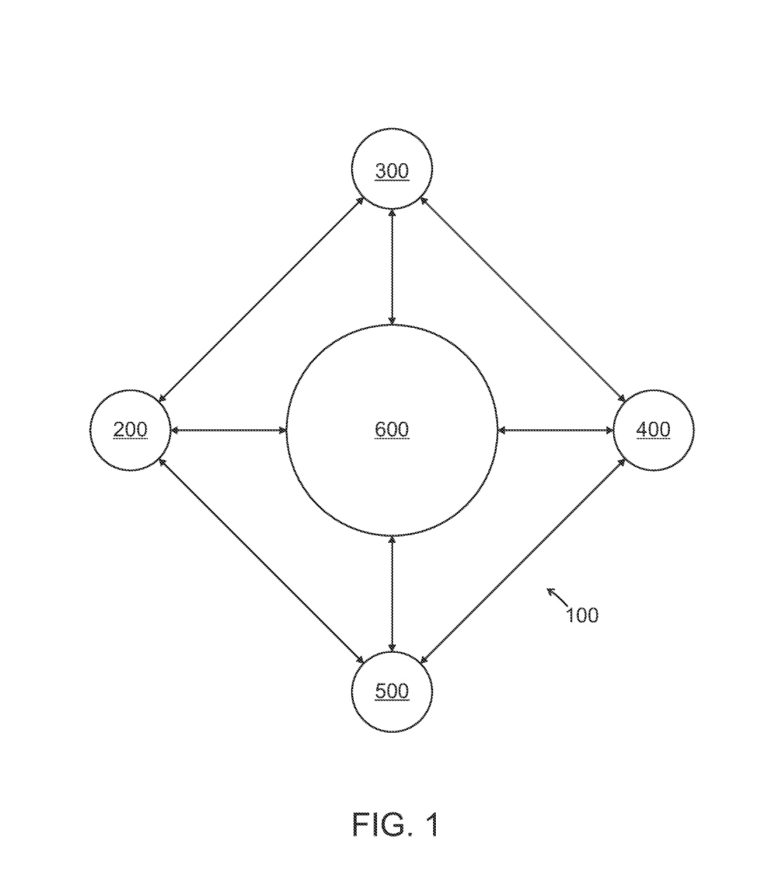

Referring now to FIG. 1, here is illustrated a system 100 for communication and processing information comprising a network of interconnected nodes 200, 300, 400, 500, 600 operatively linked, either directly or indirectly, to each other with the possibility of bidirectional wire or wireless communication and information exchange, which is illustrated by double-headed arrows. The network is preferably the Internet, but could be any kind of network, e.g. a so-called local area network (LAN). The nodes 200, 300, 400, 500 can be mobile or stationary computers, computer terminals, other networks, personal digital assistants, cellular phones, IPods®, Iphones®, data servers, bank account servers, customers, clients or users, etc. The number of nodes 200, 300, 400, 500, 600 is by no means limited to a particular number, but could be almost any number.

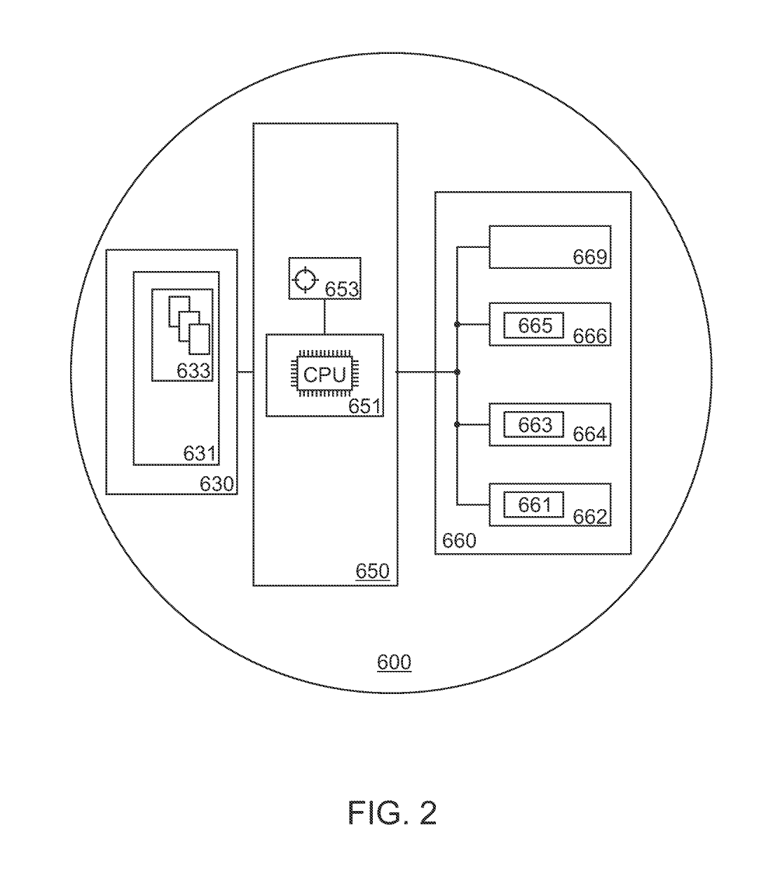

Now is illustrated and described how dynamical pricing of perishable items of goods is performed according to an embodiment of the invention, related to a method, computer program product and system. The system 100 in FIG. 1 for communication and processing information is configured as a dynamic pricing system according to an embodiment of the present invention, wherein the node 600 in the network shown in FIG. 1 is configured as a governing node of the dynamic pricing system and explicitly shown in FIG. 2.

The governing node 600 in FIG. 2 comprises at least one database 630, a computing device 650 and data storage 660 and constitutes together with the nodes 200, 300, 400, 500 shown in FIG. 1 a network which in this aspect is regarded as a virtual market place. The virtual market place is characterized in that most part of the commerce does not take place physical as in a normal market place, like a bazaar or a store where the products are offered to the customers by sales people in the store, behind stalls or from the shelves by the owner of the store. Instead the customers, or clients, get access to the items of goods, or products, for offer typically by logging into a webpage, homepage, or portal, in the “virtual world” in order to get access to the information contents of the governing node 600, such as the products for offer and their price. This can typically be performed by entering and/or selecting the web-address, domain name or IP-address. A webpage is normally accessible from any of the nodes 200, 300, 400, 500 (e.g. a client or a customer), via a web server where the customer, or client, uses a particular type of software, typically a so called web browser to access a webpage. The nodes 200, 300, 400, 500, such as communication devices used by customers, can interact with the contents in the governing node 600, for example via the web browser. The browser “reads” the contents of the database 630, or any processed contents, e.g. processed data, and provides a presentation of the contents to at least one of the nodes 200, 300, 400, 500. Of course, many other ways of interaction between the nodes and the customers are possible; like the use of be pop-ups, e-mail or SMS-reminders, or the like, moreover today constant access, such as continuous login, is possible all around the world.

The database 630 comprises a readable and writeable register 631, or data memory, wherein information related to registered items of goods 633, in particular perishable items of goods of goods, are stored. The database 630 stores the contents (i.e. the registered items of goods 633) for sale offered on the virtual market place and updated information relative to the contents, such as updated prices etc.

The information regarding the items of goods 633 is typically the price, sort or type, time- and date stamps, a related product number, the total, or remaining number of items of goods 633, time-to-live (also called time before expire) TTL, or any other type of relevant information needed to perform calculations and/or processing as well as storing the information.

The database 630 records each purchase of an item 633 and the relevant information associated with it, and the dynamic pricing in connection with the computing device 650, which perform relevant calculations such as to update the price of each item 633 for sale. This updated and the related information is typically also stored in the database 630. The price can be updated for any time period, for example every millisecond, second, minute, hour, day, week, month, and year.

The computing device 650, also referred to as a computer, comprises at least one processing unit 651, for example a CPU (Central Processing Unit), arranged to receive, transmit, route, calculate or process information (e.g. data) within the governing node 600. The processing unit 651 is typically directly connected to all other units or components within the governing node 600, such as the database 630, the data storage 660 and indirectly to all other nodes 200, 300, 400, 500 in the network 100 through their interfaces, respectively. The computing device 650 can also comprise a variety of other devices responsive to software instructions, a hardwired state device or a combination of these. The computing device 650 also comprises a time and datum device 653 for measuring, recording and synchronizing time and date in the system 100 of FIG. 1, and is typically used to time and date stamp events, such e.g. purchases, in- and/or out-going orders etc, in the system 100, but could also be used to count down the time before the items of goods 633, becomes useless or expires.

The data storage 660 comprised in the governing node 600 stores computer-executable instructions e.g. data programs, machine codes or computer software. The data storage 660 comprises a data memory 669, for example, internal RAM, ROM, hard disc, CD, USB-stick, enabling both reading data and writing new or processed information or data from and to the computing device 650, the database 630 and again restore this new or processed information in the data storage 660 as well.

The data storage 660 also resides a first set of computer-executable instructions 661 comprised in a first data storage segment 662, where the first set of computer-executable instructions 661 comprise the instructions needed to perform all steps of the inventive method for dynamically pricing the items of goods 633, e.g. the products such as perishable goods, and will be described more thoroughly in this disclosure of the invention. The purpose of the first set of computer-executable instructions 661 is that the registered items of goods 633, such as the products offered for sale on the virtual market could be provided, presented, processed and dynamically priced according to the method of the invention. These computer-executable instructions 661 are also configured to govern components within the governing node 600 in order to perform the inventive method by any associated hardwired design or computer program product, such as a particular software, but many other ways are of course conceivable.

The data storage 660 also resides a second set of computer-executable instructions 663 comprised in a second data storage segment 664, where the second set of computer-executable instructions 663 are arranged to control the communication in the system 100 (e.g. the network) between the governing node 600 and the nodes 200, 300, 400, 500. These instructions could also enable secure communication and generate digital certificates, which preferably are encrypted, compressed and signed. In administrating individual products (i.e. registered items of goods 633), especially if different customers, users or clients are involved, there is certainly a need for a set of rules which governs and protects information such as credit card and bank account communications and traceability as well as authorized response, hence the digital certificate serves as a key, or as a secure communication line, for the user. Such certificates could be generated by the computing device 650 and distributed to the nodes 200, 300, 400, 500. It should be appreciated that any, some, or all of the nodes 200, 300, 400, 500 as well as the governing node 600 could comprise computer-executable instructions, either hardwired and/or comprised as software which allow them to communicate with each other in the system and over the network.

Furthermore, the data storage 660 comprises a third data storage segment 666 comprising a third set of computer-executable instructions 665 arranged to control the basic operations of the processor 651. The third data storage segment 666 is typically a non-volatile memory and the third set of computer-executable instruction 665 could for example be an operative system, the machine code, or firmware of the computing device 650 and/or its components.

In this case, the computer-executable instructions 661, 663 and 665 are comprised in the data storage 660, but could of course also be arranged in an Internet-application. It is also conceivable that the data storage 660 is located at an external location, e.g. distributed in or at the nodes 200, 300, 400, 500.

Further alternatives and combinations of different interfaces, communications protocols, computer-executable instructions, data storages, communication links etc required will not be described in more detail since this is conventional technology and therefore obvious for a person skilled in the art of electronics and computer science to design.

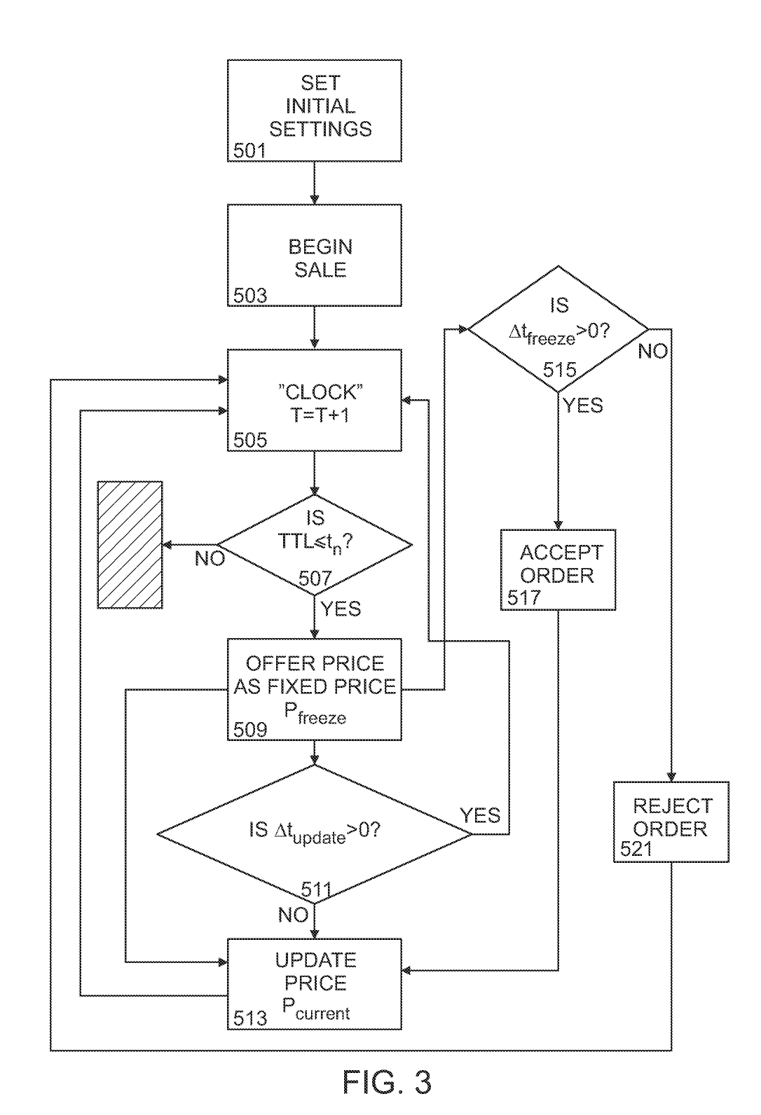

Now is also referred to FIG. 3, which illustrates an embodiment of a method according to the present invention that can be provided by means of the inventive system and computer program product described above.

To start, typically initial settings, including initial price P(0), a time-to-live parameter TTL and update frequency time period ΔT_{update} is set 501. Then sale of goods having a current price P_{current} at a first time (t=t₀) begins 503.

To begin with, initial settings are set 501, a total number of items of goods 633, in particular perishable items of goods, are registered in the database 630 and offered 503 for sale to begin. The number of perishable items of goods 633 offered for sale can be limited. The unique characteristics of perishable items of goods is that perishable items of goods are products, or goods, which value is to deteriorate or decay to the point of being unserviceable, useless or worthless, and by their very nature cannot be conserved indefinitely. Examples of perishable items of goods 633 could be tickets to an event, tickets for travelling, accommodations such as hotel rooms, provisions with a best-before-date, and the like.

To the items of goods 633 are associated a particular set time-to-live parameter TTL. This time-to-live parameter TTL is defined as the difference between the point in time the sale commences, or has commenced, i.e., t=t₀, and the maximum point in time the items of goods 633 becomes worthless or useless, i.e. t=tₙ. Some typical examples of when items of goods become worthless are concert tickets after the concert has begun, train tickets just after departure, the expire of best-before-date of provisions like milk, meat, fish in a grocery store or the like. This time could also be any point in time the sale ends due to any particular restriction in time or any other reason. The entire time the items of goods 633, i.e. the products, will “live” in this respect is then the time it will become worthless subtracted with the time the sale commenced (tₙ−t₀), i.e. TTL≦tn is controlled.

As an illustrative example, assume we have a limited amount of one hundred tickets for a music concert that will occur the next week, which tickets we now offer for sale on the virtual market. Each ticket will then have a time-to-live parameter TTL value of one week, and as soon as they are offered for sale the time-to-live TTL of each ticket, i.e. each item 633, starts to decrease. It could be convenient to convert absolute time (minutes/hours/days etc) into relative time, and absolute volume (number of items of goods sold) into relative volume. Converting absolute time into relative time can be done by first subtracting the time when the sale commenced (t₀) from the current time (t), that is (t−t₀), or in discrete form (tᵢ), Δ tᵢ=(tᵢ−t₀). Then the ratio, where the difference (t−t₀) is placed in the numerator, and the time-to-live TTL, i.e. (tₙ−t₀) in the denominator, i.e. [(t−t₀)/(tₙ−t₀)], varies between 0 to 1, or between 0 to 100%, which is a convenient way to illustrate how long the items of goods 633 have “lived” or existed, and how much time they have left before they will “perish”, i.e. 1−[(t−t₀)/(tₙ−t₀)]. When this ratio equals 1, or 100%, “time's up” for the perishable items of goods 633, and they are after that regarded as worthless or useless.

The initial price setting 501 is preferably performed by using some sort of price estimation method where information regarding the items of goods 633 is used as a basis for that estimation. If there have been similar sales situations in the past, these can be used in order to estimate an average cumulative volume function ACV (t) and hence the initial price. Given that there is historical sales data (time and price for each item sold at hand) the cumulative volume sold as a function of time can be estimated empirically.

The average cumulative volume function ACV(t) is determined by estimating the cumulative volume sold as a function of time: CV(t)=f(t). The cumulative volume function can take different forms, as for instance: linear CV(t)=a+bt; exponential, logarithmic or any combination of these, as well as a plurality of other function types. The average cumulative volume function is ACV(t)=ΣCV(t)/N, where N are the number of sold items of goods.

The estimation can for instance be done with the Ordinary Least Squares regression methodology: ACV(t)=a+bt+ct²+dt³+e In(t)+ε

where ε is the error term containing the estimations error, and a, b, c, d, e are parameter estimates; or in matrix algebra y=Ax, where A is the matrix for an over determined system of linear equations, and if transpose matrix A^{T} exists, we have A^{T} y=A^{T}Ax, and hence the solution is the vector x=A^{T} y. where regression here means that the sum of the squares of the deviations are minimized according to least square.

According to an embodiment of the present invention, a time-to-live parameter TTL corresponding to a maximum time period (t=tₙ) an item of goods is good for sale is controlled 507, and if time-to-live parameter TTL≦tₙ. Then an update frequency time period ΔT_{update} is counted down 511 until the price is updated. When a potential buyer ask for a quote a freezed price P_{freeze} is offered 509 for a strictly limited time Δt_{freeze}. The current price Pcurrent which is offered to other buyer is then instantaneously updated, also referred to as updated, to reflect the said potential buyers interest.

If an order to buy the item of goods is received 515 before end of the limited time Δt_{freeze}, the order is accepted 517.

The order is rejected 521 if the order is received after 515 the limited time period Δt_{freeze} has elapsed.

The current price P_{current} of the item of goods is automatically updated 513 in accordance with time of offering price as fixed price 509, elapsing of update frequency time period ΔT_{update} 511, and time of receiving order 517 to buy the goods, and the steps above are automatically repeated until the time period t=tₙ equals the time-to-live TTL parameter.

The dynamic price function which in one embodiment of the invention will dynamically yield the price of the perishable items of goods 633 is given below.

P(tᵢ)=α*(CV(tᵢ)/ACV(tᵢ)−1)*P(t₀)+P(t₀), or

P(tᵢ)=α*(CV(tᵢ)−ACV(tᵢ))/ACV(tᵢ)*P(t₀)+P(t₀) (equation 1)

The coefficient α is set according to how aggressively the seller wants the price to update (α=1 being one obvious alternative).

By inserting the current time into the estimated cumulative volume sold as a function of time, we will get an estimate of how many items of goods 633 should have been sold in order for all the items of goods to be sold at a n:th time t=tₙ given the estimated cumulative volume sold as a function of time.

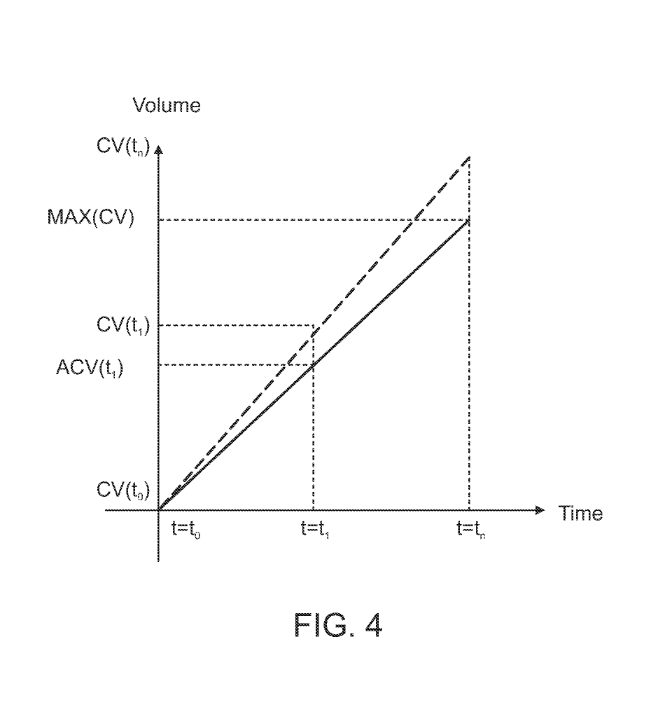

To illustrate how a dynamic price is set consider equation 1 above, as can be seen in FIG. 4; Here CV(t) is the cumulative volume, that is how many items of goods 633 that have been quoted or sold at time t. If CV(t)>ACV(t) then the difference CV(t)−ACV(t) will be positive, and if CV(t)<ACV(t), the difference will be negative, and as can be seen in equation 1, the update price will in the first case increase, and in the latter case decrease from the previous price.

Typically, the initial price P(t0) is set to the highest price that is estimated to sell the maximum volume of the perishable goods MAX(V) at the n:th time t=tₙ. To illustrate this further, assume the sale begins at time initial time t₀ with initial price P(t₀), which is the seller's best estimate for a price that will sell exactly all of the perishable goods MAX(V). The initial price P(t₀) would hence typically correspond to an ex-ante estimated fixed price. Also, a minimum price MIN(P) is set, which for instance could equal to the marginal delivery cost for one unit of the perishable goods in question.

At a first time t=t₁ cumulative volume CV(t₁), i.e. the dotted line in FIG. 4, has been quoted or sold. By inserting the first time t=t₁ into the average cumulative volume function ACV(t₁), i.e. the solid line in FIG. 4, we get an estimate of how many items of goods should have been sold in order for exactly the maximum volume MAX(V) be sold at the n:th time t=tₙ. The first price P(t₁) is now set to:

P(t₁)=α*(CV(t₁)/ACV(t₁)−1)*P(t₀)+P(t₀)

where P(t₀) is the initial price at initial time t=t₀.

In the example illustrated in FIG. 4 P(t₁)>P(t₀) as CV(t₁)>ACV(t₁):

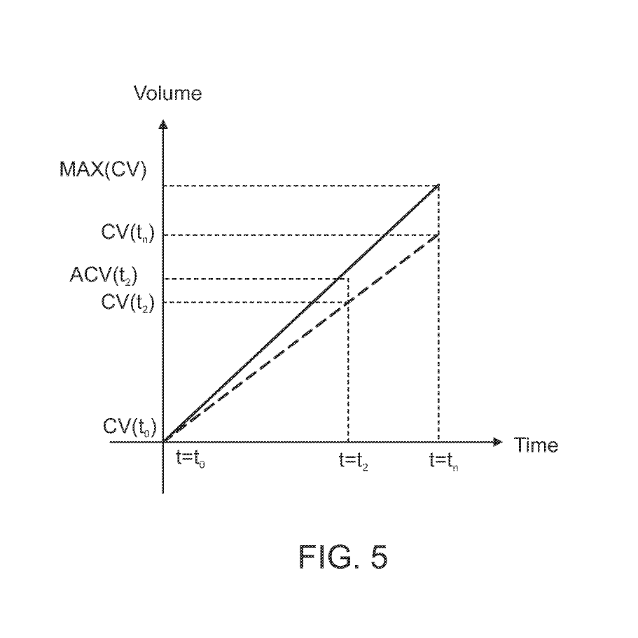

In FIG. 5:

At time a second time t=t₂, a second volume V(t₂) has been sold, i.e. the dotted line in FIG. 5. The second price at the second time P(t₂) is now set to:

P(t₂)=α*(CV(t₂)/ACV(t₂)−1)*P(t₀)+P(t₀),

In the example illustrated in FIG. 5, P(t₂)<P(t₀) as CV(t₂)<ACV(t₂):

Selling ends as items of goods, i.e. product perishes at the n:th time t=tₙ. The price database contains complete history of sales price, volume and time, which can be used in order to estimate average volume function for another product and at other occasions.

Thus, as could be concluded from the above, the dynamic method for dynamically pricing perishable items of goods will update the dynamic price for every moment in time so that exactly all of the items of goods are sold at the highest possible average price before the point in time any remaining items of goods become worthless. However the price of any individual item should always be higher than or equal to the marginal costs which the seller incurs as a consequence of selling the item.

Although important, the estimation of the cumulative volume function ACV(t) is in comparison with the method for dynamically pricing of secondary importance since the method for dynamically pricing very rapidly will update any errors in the average cumulative volume function ACV(t) due to the continuous information flow in the system once the sale has commenced, and will correlate this information with any data registered in the database 630 for the particular sales situation at hand.

Once the initial price of the items of goods 633 is set, communicated (e.g. presented at the homepage, or broadcasted to the nodes in the system) on the virtual market, the algorithms for the dynamical pricing method determined and the commence starts, this price is continuously updated as a dynamic price. If a customer (e.g. a node in the system) initiates a request to order, “quote”, the dynamic price is presented as a temporary frozen price during a limited time period, Δt_{freeze}.

Typically, according to an embodiment of the present invention, a fixed price if offered for a maximum MAX(V) number of items during a limited interval of time Δt_{freeze} for each customer session (or demand). The current price P_{current} is updated also based on the demand, or “quote”. If the price is confirmed by the customer within the time period Δt_{freeze}, the order is accepted, otherwise, a new price, equal to the current price P_{current}, offered is presented to the customer having a new Δt_{freeze}. This provides a more efficient pricing since it hinders a customer “fishing” for a good price by means of asking a large number of price offered.

One preferred aspect of the invention is to dynamically update the price of the items of goods 633 in accordance to the real demand on the virtual market with the objective of selling all of the items of goods 633 for sale before the point in time any remaining items of goods become worthless. Thus there is a given inventory of items of goods 633 to be sold out before their time-to-live TTL ends. This is typically also combined with a mechanism to restrict the possibility to order all, or a large number, of the items of goods 633 offered for sale during at least one occasion, since it would otherwise be possible to order all of the items of goods 633 when the price is favorable and then in turn offer them for sale on a secondary market. The possibility to order items of goods 633 is thus only valid for a certain volume at one time; and even if this might be seen as a small detail, it is in fact a crucial feature of the invention since this will introduce strictly limited liquidity on the virtual market which reduces the risk of secondary markets to arise.

Therefore the total number of items of goods 633 offered for sale is divided into parts and offered to the customers on the virtual market in such parts. Each such part will for convenience hereafter be called a package which is a particular subset of all the items of goods 633 registered in the database 630. Hence, the maximum numbers of items of goods 633 an interested customer can order at a single occasion are the number of items of goods 633 in a single package during the limited time Δt_{freeze}. If at least one of the items of goods 633 in one such package is ordered during that particular limited time Δt_{freeze}, the dynamic price is updated immediately in the system for other customers who have not initiated a request to order.

If no item 633 is ordered during a time interval update Δt_{update}, the dynamic price is also updated 513 after the time interval update Δt_{update} has elapsed 511. Hence, the dynamic price is updated 513 both when there is a sale and when there is no sale. It is also preferred to emphasize that the invention makes use of both information given every time there is a sale as well as when there is no sale. In both cases the dynamic price converges towards the real demand for the particular sale situation at hand. In the first case, i.e. when there is sale, the dynamic price will normally increase in order to lower the demand, and in the second case, i.e. when there is no sale, the dynamic price will normally decrease in order to stimulate the demand.

The activity on the virtual market is also of high interest. If, for example a lot of customers visit the homepage (e.g. found out by analyzing the number of IP addresses logged in) but do not order any item 633, this is typically also important information, since a high activity at the homepage but low or no request of orders indicates that the time interval update Δt_{update} typically should be decreased in order to stimulate the demand. If there is low activity, e.g. during the night, the time interval update Δt_{update} may be prolonged between the updates since the decrease of the dynamic price could otherwise be to rapid. Another way to tackle this problem could be that the dynamical price is not allowed to decrease below a certain threshold value, which for example could be determined by the margin costs of the items of goods 633. From the IP addresses the system can estimate how many customers that are logged-in, and could automatically change the length of the time interval update Δt_{update} or other essential parameters in accordance with that information.

To illustrate the feature of the invention which restricts the possibility to order a large or high volume of items of goods 633 during one or a few successive number of occasions, assume the one hundred tickets mentioned as an example above are split into packages of for example five tickets each. The number of packages offered for sale on the virtual market simultaneously will hence be twenty and once a customer, who typically is logged in on the homepage has initiated a request to order at least one ticket (i.e. an item 633), for example by pushing a “QUOTE-button”, or the similar, the dynamic price is temporarily frozen for that customer during the time slot Δt_{freeze}. By this is meant that the price is fixed at a particular level during that time slot Δt_{freeze} on behalf of that specific customer. This temporary frozen price is a snap-shot of the dynamic price at that instant which is hold during the time slot Δt_{freeze}—but the dynamic price is continuously computed by the computing device as a response of the demand (both quotes and actual sales) on the virtual market. Hence, the dynamic price is immediately updated in accordance with a temporarily frozen dynamic price and volume being offered (quoted) to a customer. This difference could for example be presented for the customers in two different windows on the homepage, where typically also information regarding how much time is left of the temporarily frozen time slot Δt_{freeze} with the particular offered frozen dynamic price is displayed, for example in a window with the text “now there is only x seconds left to order for this frozen dynamic price”. To temporarily freeze the dynamic price makes it possible for the customer, once he, or she, has initiated a request to order, to enter specific details associated with the order like e.g. number of tickets (i.e. items of goods 633) wanted, a credit card number, home address, email address, telephone number, bank, etc without the risk of that the dynamic price will change during the often time consuming moment of entering such details to the vendor. If a smaller amount of tickets is ordered of a customer, for example only two tickets in the offered package of five, the dynamic price is changed in accordance with that sale and immediately updated in the system. If other customers have initiated an order, they could see this updated dynamic price, but their price is still valid during their individually associated time slot Δt_{freeze}.

Even if the twenty packages are offered on the virtual market simultaneously it is only possible for one single customer to order a maximum of one package (comprising five tickets) for the, at that instant, offered price during the, to that customer associated, time slot Δt_{freeze}. The customer's ID is typically confirmed in some way by the system where the customer's IP-address associated with his device is one obvious alternative. Typically, the first order influences the price of the second order even if they arrive very close in time to each other.

As already indicated this feature of the invention will make it harder for a wholesaler (or several) to make profits on a secondary market by buying all or a large number of the items of goods 633. For example, all or a large number of the tickets to a music concert with a famous artist, or a popular sports event, and hold on them until just days or even hours before the event is about to occur in order to maximize the profit for themselves. This is significant since secondary markets tend to cause inflation and distort the balance of the economy.

The following example illustrates one aspect of dealing with delayed buying orders of the invention. Assume the commence starts at time 12:00:00 for the initial price 100 USD. One package comprises five items of goods, the update time period Δt_{update} is five seconds and the dynamic price is updated after the update time period Δt_{update} has elapsed, and at every quote and sale. The limited frozen price time period Δt_{freeze} is set to two seconds, which means that orders are accepted up to two seconds after the dynamic price has been quoted to a customer as a fixed price.

| | |
|---|---|
| 12:00:00 | The sale begins. |
| 12:00:01 | Two items of goods are quoted to a customer at a frozen price of |
| | 100 USD each, the dynamic price is updated to 105 USD. |
| 12:00:03 | An order of two items of goods 633 for 100 USD each (V = |
| | 2@_100 USD) is received within Δt_{freeze}, herein two seconds, |
| | and accepted, the dynamic price is updated to 110 USD. |
| 12:00:08 | Five time units without quotes or sales, the dynamic price is |
| | decreased and updated to 105 USD |
| 12:00:10 | Four items of goods are quoted to a customer at 105 USD each, |
| | the dynamic price is updated to 115 USD |
| 12:00:15 | Five time units without quotes or sales, the dynamic price is |
| | decreased and updated to 110 USD |

Other alternatives and combinations are of course possible, and such will not be described in more detail since this is conventional technology and therefore obvious for a person skilled in the art of electronics and computer science to design:

According to another further embodiment of the invention the virtual market could also be any physical market offering perishable goods as well, such as food articles in a grocery store, a shop, warehouse etc. Any of the nodes in the virtual market could also in some way be closer associated with a physical market—a node could for example be at least one physical stationary cash register disposed at any store (products, food),a movie theatre, zoo, museum, gallery, amusement park, or the like.

What is claimed is:

1. A method for dynamically pricing perishable goods in a goods order system, the method comprising the steps of:
a) controlling a time-to-live parameter (TTL) corresponding to a maximum time period (t=tₙ) an item of goods is good for sale, and if time-to-live parameter (TTL)≦tn, then,
b) counting down an update frequency time period (ΔT_{update}) until the price is updated;
c) if interest to buy the goods (asking for a “quote”) is received, offering a temporarily fixed price P_{freeze} equal to current price (P_{current}) for a limited time period (Δt_{freeze});
d) automatically updating the current price (P_{current}) according to the expressed interest to buy the goods;
e) accepting order at temporarily fixed price Pfreeze if order (“buy”) is received within strictly limited time period Δt_{freeze};
f) rejecting the order if order is received after limited time period Δt_{freeze};
g) automatically updating the current price (P_{current}) of the item of goods in accordance with time of receiving accepted order, or elapsing of update frequency time period (ΔT_{update}); and
automatically repeating the steps b)-g) until the time period (t=tn) equals the time-to-live (TTL) parameter.

2. The method according to claim 1, further comprising the step of:
setting initial settings, including initial price P(0), the time-to-live parameter (TTL) and update frequency time period (ΔT_{update});
beginning sale of goods having a current price (P_{current}) at a first time (t=t0).

3. The method according to claim 1, further comprising the steps of:
offering a temporarily fixed price P_{freeze} equal to current price (P_{current}) for a limited time period (Δt_{freeze}) and updating the current price (P_{current}) accordingly, and
accepting order if time (t) is less than or equal to a strictly limited frozen price time Δt_{freeze} and updating the current price (P_{current}) accordingly.

4. The method according to claim 2, wherein the initial price P(0) is set to the highest price that will sell the maximum volume of the perishable goods MAX(V) at time t=tₙ.

5. The method according to claim 2, wherein a minimum price MIN(P) is set.

6. The method according to claim 3, further comprising the step of:
inserting time t=t₁ into an average volume function AV(t) to estimate how many items of goods should have been sold in order for exactly the maximum volume MAX(V) to be sold at time t=tₙ, based an volume V(1) that has been sold to price P(1).

7. The method according to claim 6, wherein
in case of no new sale, after a predetermined time interval (Tᵢₙₜ), inserting time T=2 into the average volume function AV(T) to estimate how many items of goods should have been sold in order for exactly the maximum volume MAX(V) to be sold at time T=N, based an volume V(2) that has been sold to price P(2).

8. A computer program product comprising computer-readable medium comprising code for causing a computer to:
control a time-to-live parameter (TTL) corresponding to a maximum time period (t=tₙ) an item of goods is good for sale, and if time-to-live parameter (TTL)≦tₙ, then;
count down an update frequency time period (ΔT_{update}) until the price is updated;
offer fixed price for a limited time period (Δt_{freeze}).
update current price (P_{current}) to reflect the offered fixed price;
accept order if order to buy the goods is received before end of the limited time period (Δt_{freeze}),
automatically update the current price (P_{current}) of the item of goods in accordance with time of receiving order or update frequency time period (ΔT_{update}), and
automatically repeat the steps above until the time period (t=tₙ) equals the time-to-live (TTL) parameter.

9. A system for dynamically pricing perishable goods in a goods order system comprising a network of interconnected nodes operatively linked, wherein the governing node comprises at least one database, a computing device and data storage, wherein the database comprises a readable and writeable register, or data memory, wherein information related to registered items of goods, in particular perishable items of goods of goods, are stored, wherein the database is arranged to store the registered items of goods for sale offered on the virtual market place and updated information relative to the contents, wherein the governing node is arranged to cause a computer to:
control a time-to-live parameter (TTL) corresponding to a maximum time period (t=tₙ) an item of goods is good for sale, and if time-to-live parameter (TTL)≦tₙ, then;
count down an update frequency time period (ΔT_{update}) until the price is updated,
offer a fixed price for a strictly limited time period (Δt_{freeze});
update current price (P_{current}) to reflect the offered fixed price;
accept order if order to buy the goods is received before end of strictly limited time period (Δt_{freeze}),
automatically update the current price (P_{current}) of the item of goods in accordance with time of receiving order or update frequency time period (ΔT_{update}), and
automatically repeat the steps above until the time period (t=tₙ) equals the time-to-live (TTL) parameter.
